(19) United States
(12) Patent Application Publication
(10) Pub. No.: US 2025/0052893 A1
(43) Pub. Date: Feb. 13, 2025

(54) JOINT COMMUNICATION AND SENSING APPLICATIONS

(71) Applicant: Apple Inc., Cupertino, CA (US)

(72) Inventors: Jochen Schrattenecker, Alberndorf in der Riedmark (AT); Michael Hofstadler, Luftenberg (AT); Reinhard Feger, Scharnstein (AT); Andreas Springer, Linz (AT); Andreas Stelzer, Linz (AT)

(21) Appl. No.: 18/799,997

(22) Filed: Aug. 9, 2024

Related U.S. Application Data
(60) Provisional application No. 63/518,939, filed on Aug. 11, 2023.

(51) Int. Cl. G01S 13/89; G01S 13/58

(52) U.S. Cl. CPC G01S 13/89; G01S 13/58

(57) ABSTRACT

Embodiments are disclosed for joint communication and sensing (JCAS) applications with user equipment (UE) including collision alert detection, user vital signs detection, active autofocus in low-light conditions for camera applications and infrared spectroscopy to detect and identify components of a sample of material. Also disclosed is the use of an apodization range-velocity map to improve detection of targets.

### CROSS-REFERENCE TO RELATED APPLICATION

This application claims priority to U.S. Provisional Patent Application No. 63/518,939, filed Aug. 11, 2023, the entire contents of which are incorporated herein by reference.

### TECHNICAL FIELD

This disclosure relates generally to joint communication and sensing (JCAS) applications.

### BACKGROUND

JCAS integrates radio sensing into user equipment (UE) to sense static and moving objects in an environment surrounding the UE, using for example 5G New Radio (NR) or 6G waveforms. Some examples of sensing parameters, include but are not limited to range, velocity, and angle of arrival (AoA).

### SUMMARY

Embodiments are disclosed for joint communication and sensing (JCAS) applications with user equipment (UE) including collision alert detection, user vital signs detection, active autofocus that is light independent (e.g., active autofocus in all light conditions, including low-light conditions) for camera applications and infrared spectroscopy to detect and identify components of a sample of material. Also disclosed is the use of an apodization range-velocity map to improve detection of targets.

In some embodiments, a method comprises: transmitting, with a joint communication and sensing system implemented in user equipment (UE), orthogonal frequency-division multiplexing (OFDM) waveforms into an environment; determining, with at least one processor, if at least one precondition is met; responsive to determining that at least one precondition is met, triggering, with the at least one processor, a collision alert application on the UE; processing, with the at least one processor, received OFDM waveforms reflected from at least one object in the environment; determining, with the at least one processor, at least one sensed parameter determined from the received OFDM waveforms; comparing, with the at least one processor, the at least one sensed parameter to at least one threshold for presenting at least one collision alert; and responsive to the at least one sensed parameter meeting the at least one threshold, presenting the at least one collision alert to the user.

In some embodiments, a method comprises: transmitting, with a joint communication and sensing system implemented in user equipment (UE), orthogonal frequency-division multiplexing (OFDM) waveforms into an environment; processing, with at least one processor, received OFDM waveforms to determine at least one sensed parameter associated with at least one vital sign of a user; determining, with at least one processor, that the at least one sensed parameter meeting at least one precondition; responsive to the at least one sensed parameter meeting at least one precondition, triggering, with the at least one processor, recording of the at least one sensed parameter or other data; and storing, transmitting, or making the recording available to at least one application or framework.

In some embodiments, a method comprises: transmitting, with a joint communication and sensing system implemented in user equipment (UE), orthogonal frequency-division multiplexing (OFDM) waveforms into an environment; triggering, with at least one processor, autofocus (AF) for a camera system in the UE in response to at least one precondition being satisfied; processing, with the at least one processor, received OFDM waveforms; determining, with the at least one processor, an estimated range to an object from the received OFDM waveforms; determining, with at least one processor, if the estimated range can be used for AF; and responsive to determining that estimated range can be used for AF, sending the estimated range data to the camera system for use in AF.

In some embodiments, a method comprises: transmitting, with a joint communication and sensing system implemented in user equipment (UE), orthogonal frequency-division multiplexing (OFDM) waveforms into an environment; processing, with the at least one processor, received OFDM waveforms to determine a molecular signature from spectra of the received OFDM waveforms; and identifying, with the at least one processor, a molecule based on a comparison of the signature with a database of reference signatures and selecting a closest matching reference signature as the identity of the molecule.

In some embodiments, an infrared laser on the UE is used like a light source to excite the vibrational or electron state of a molecule. The spectra of the reflected laser is analyzed by a processor of the UE to identify transition energies and therefore identify the molecule.

In some embodiments, an apparatus comprises: at least one processor; memory storing instructions that when executed by the at least one processor, cause the at least one processor to perform any of the preceding methods.

In some embodiments, a computer-readable storage medium has instructions stored there that when executed by one or more processors of a UE, perform any of the preceding methods.

In some embodiments, a method comprises: transmitting, with a joint communication and sensing system implemented in user equipment (UE), orthogonal frequency-division multiplexing (OFDM) waveforms into an environment; processing, with the at least one processor, received OFDM waveforms reflected from at least one object in the environment, the process including: downconverting the received OFDM waveforms into baseband signals; applying an optimized window to channel information extracted from the baseband signals; applying a frequency transform to the windowed baseband signals to obtain windowed range-velocity maps; generating, with the at least one processor, an apodization range-velocity map from the windowed range-velocity maps; and estimating, based on the apodization range-velocity map, the range and velocity of the at least one object.

In some embodiments, the apodization range-velocity map is generated by computing an element-wise minimum of the windowed range-velocity maps.

Other embodiments are directed to an apparatus, system, and computer-readable medium.

Particular embodiments described herein provide one or more of the following advantages. JCAS allows for an existing wireless communication stack and hardware embedded in a mobile device (e.g., smartphone) to be used for both wireless communication and sensing using fully compliant 5G NR or 6G waveforms.

### BRIEF DESCRIPTION OF THE DRAWINGS

FIG. 1 is a block diagram of a system that performs JCAS operations, according to one or more embodiments.

FIG. 2 is a flow diagram of a process for a collision alert application using JCAS parameters, according to one or more embodiments.

FIG. 3 is a flow diagram of a process for a camera autofocus application under low-light conditions using JCAS parameters, according to one or more embodiments.

FIG. 4 is a flow diagram of a process for a vital sign detection application using JCAS parameters, according to one or more embodiments.

FIG. 5 is a block diagram of a spectroscopy application using JCAS parameters, according to one or more embodiments.

FIG. 6 is a block diagram of a mobile device architecture for implementing the system, features and processes described in reference to FIGS. 1-6.

FIG. 7A illustrates a transmission (TX) resource grid with uniform resource distribution, according to one or more embodiments.

FIG. 7B is a range-velocity map showing the resulting range-velocity peak for two targets based on the TX resource grid of FIG. 7A, according to one or more embodiments.

FIG. 7C illustrates a TX resource grid with non-uniform resource distribution, according to one or more embodiments.

FIG. 7D is a range-velocity map showing the resulting range-velocity peak for two targets based on the TX resource grid of FIG. 7C, according to one or more embodiments.

FIG. 7E illustrates the problem with non-uniform resource distribution, where sidelobes of the sinc function in a range-velocity map of the combined target reflections obfuscate the peak of one of the targets, according to one or more embodiments.

FIG. 8 is a flow diagram of a process that improves the estimate of target range-velocity using an apodization map, according to one or more embodiments.

### DETAILED DESCRIPTION

### JCAS System Overview

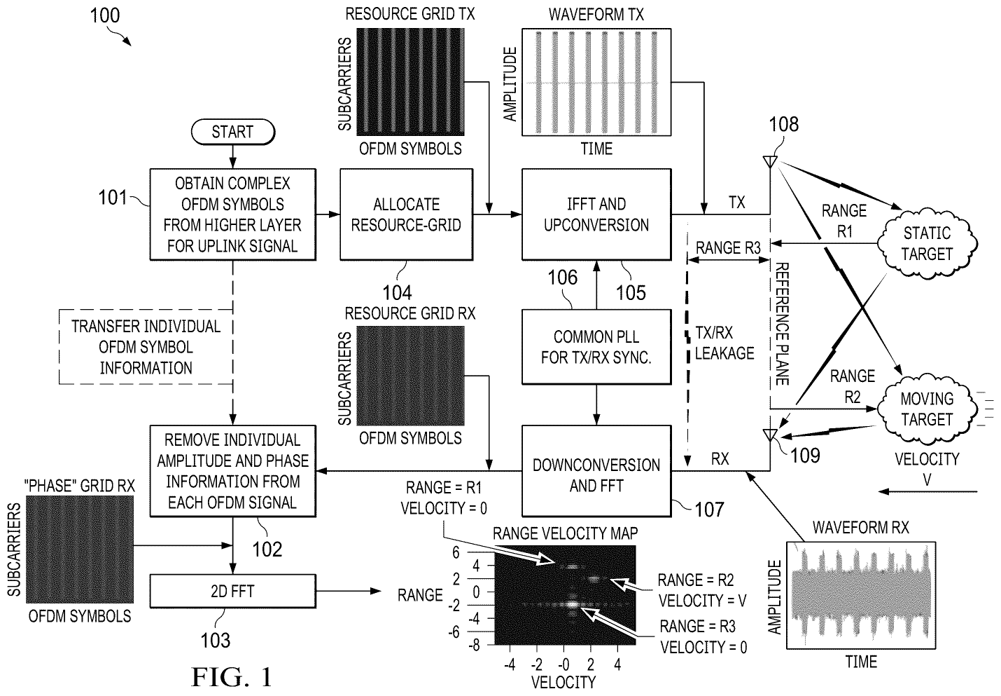

FIG. 1 is a block diagram of system 100 that performs JCAS operations, according to one or more embodiments. Although system 100 can perform both communication and sensing operations, only the sensing function is described below.

Referring to the transmit (TX) path of system 100, orthogonal frequency-division multiplexing (OFDM) symbols are obtained from a higher layer of the wireless communication stack (e.g., 5G stack). In other embodiments, system 100 includes a complex OFDM symbol generator that generates OFDM symbols. A TX resource grid (e.g., 5G standard-compliant resource grid) is generated 104 that includes a set of allotted resources (e.g., resource elements or blocks) in units of time (e.g., as partitioned into OFDM symbols) and frequency (e.g., as partitioned into subcarriers) that correspond to the set of complex OFDM symbols. The TX resource grid may be organized and structured according to a wireless communication standard and is therefore referred to herein as a standard-compliant resource grid. In general, different standards may specify different resource grid allocations and/or structures.

An inverse Fast Fourier transform (IFFT) and upconverter are applied to the subcarriers to generate TX OFDM waveforms (uplink signals) which are transmitted into the environment by TX antenna 108. The IFFT may perform the IFFT operation and parallel-to-serial conversions on the RX resource grid and may also add a cyclic prefix (e.g., as required by the communication standard) to produce standard-compliant TX OFDM waveforms (e.g., 5G New Radio (NR) FR2 waveforms) in the time-domain that is passed to an upconverter, which converts the baseband signals to radio frequencies for transmission. In some embodiments, the TX OFDM waveforms may include a signal burst that corresponds to where the allocated subcarriers are in the RX resource grid. In some embodiments, the TX waveforms include a sounding reference signal (SRS) waveform for use in spatial ranging operations, which are regularly and continuously transmitted at frequent and predictable intervals, to allow nearby wireless base stations to estimate the UE device channel quality. The TX OFDM waveforms are reflected by an external static or moving object (moving at velocity V), which are located at a ranges R1 and R2, respectively, measured from a reference plane defined at the TX antenna location.

Referring to the RX path of system 100, the reflected waveforms are received by receive (RX) antenna 109. A downconverter is applied to the received waveforms 107 to down convert the RX waveforms (down convert from radio frequency signals to baseband signals), and an FFT is applied to the baseband signals to generate a RX resource grid. Individual amplitude and phase information is removed 102 (e.g., using element-wise division for/on each resource grid element of a selected subcarrier of interest) from each OFDM symbol in the RX resource grid using individual OFDM symbol information transferred from the TX path. An FFT is applied to the individual amplitude and phase information to generate a Range Velocity Map (range versus velocity) from which the ranges R1 and R2 (and velocity V) are estimated based on the distance between peaks detected in a power spectrum as a function of range.

In some embodiments, a coarse peak searcher and range finder determine a range R based on the distance between peaks, and a fine peak searcher and range finder perform a finer (more precise) peak and range detection on the complex-valued range profile. In some embodiments, data is collected from two or more RX antennas (e.g., or elements of an antenna array) and used to determine angle of arrival (AOA) based on a time difference of arrival (TDOA) based on a difference of received phase for each antenna (or elements of an antenna array).

In some embodiments, a range error R3 due to electromagnetic leakage between TX and RX paths is estimated and removed from the desired estimated ranges R1 and R2. In some embodiments, a common phase lock loop (PLL) is used to sync the upconverter/IFFT and downconverter/FFT operations to reduce range errors due to clocking errors.

During wireless data communication operations (e.g., without performing spatial ranging operations), the RX path and receive antenna 108 are inactive while the TX path and TX antenna 109 transmit SRS signals. However, when system 100 is using SRS signals to perform spatial ranging operations, the RX path and receive antenna 108 remain active while the TX path and transmit antenna 109 transmit SRS signals. In another example, the standard-compliant waveform used for spatial ranging operations includes the wireless communication data waveforms themselves (e.g., wireless data packets that convey message data, application data) transmitted over a physical uplink shared channel (PUSCH) or another channel. As such, the TX waveforms that are used to perform spatial ranging operations are concurrently used for the transfer of wireless communications data and/or other standard-specified control, reference, channel quality assessment, or signaling functions, thereby minimizing the impact of spatial ranging operations on wireless data communications.

A further detailed description of system 100 can be found in U.S. patent application Ser. No. 18/167,017, for “Electronic Devices with Standard-Compliant Sensing Capabilities,” filed on Feb. 9, 2023, which is incorporated by reference herein in its entirety.

### JCAS Applications

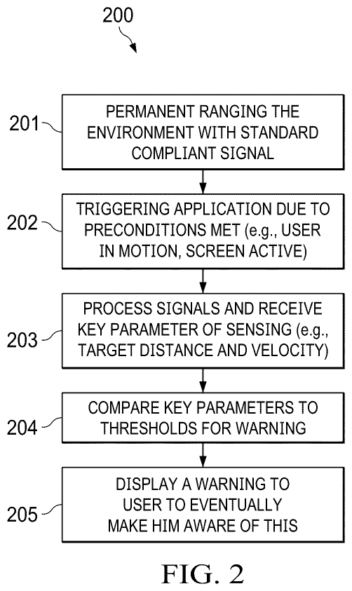

FIG. 2 is a flow diagram of a process 200 for collision alert for a pedestrian mobility scenario using JCAS parameters, according to one or more embodiments. An example scenario is a user who is walking along a crowded street and is focused on the UE display and is not paying attention to the environment. In this scenario, there is a potential risk of accident due to obstacles or traffic colliding with the user. The UE senses the potential risk and presents a warning to the user of the potential risk.

Process 200 can be implemented by UE, such as a smartphone or smart watch. Process 200 includes: ranging the environment with standard-compliant TX OFDM waveforms (201), triggering a collision alert application on the UE due to certain precondition(s) being met (202), processing RX OFDM waveforms reflected from object(s) in the environment, determining sensed parameter(s) from the RX OFDM waveforms (203), comparing the sensed parameter(s) to threshold(s) for initiating a collision alert (204), and responsive to the sensed parameter(s) meeting the thresholds, presenting at least one collision alert to the user (205).

In some embodiments, a precondition is a determination that the user is walking (e.g., based on inertial sensor data) and that the display of the UE is active (indicating that the user may not be paying attention to the environment). To determine if the user is walking, a digital pedometer on the UE can calculate a step frequency based on acceleration data (e.g., from accelerometers). The step frequency is compared to a threshold over a specified period of time to determine that the user is walking. In some embodiments, sensed parameters include the range, velocity, and angle of arrival of at least one object in the environment, as described in reference to FIG. 1.

The user's walking trajectory can be predicted in any suitable travel reference frame based on the user's location, velocity, heading (e.g., computed from satellites, inertial sensors, or both) and map data. The trajectory of any moving object is also predicted in the travel frame based on the sensed range, velocity, and angle of arrival of the moving object and map data. Based on the predicted trajectories of the user and static and moving object(s) in the environment, a determination is made on whether the trajectories will intersect (or will be sufficiently proximate to each other) at a specified future time with a static or moving object, such that a potential collision may occur. Based on this collision prediction, a collision alert is presented to the user. The collision alert can be a visual alert (e.g., via a display of the UE), an audio alert (e.g., via a loudspeaker of the UE), a haptic or tactile alert (e.g., via a haptic engine of the UE), or any combination of the foregoing.

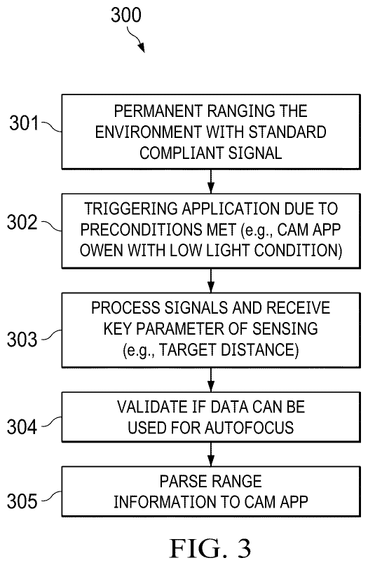

FIG. 3 is a flow diagram of a process 300 for camera autofocus under low-light conditions using JCAS parameters, according to one or more embodiments. An example scenario is the user wants to take a picture in a low-light environment of objects that are a greater distance from the camera, such as, e.g., a person, car, or house. Auto focus (AF), which is crucial for taking quality pictures, may be difficult under low-light conditions. For example, a conventional “Active AF” system works by shooting a red laser beam on the object, which reflects off the object and returns to the camera where it is used to determine the distance between the camera and the object based on time-of-flight. Once the camera knows the distance to the object, the camera lens is adjusted to focus based on the distance. Active AF is advantageous over Passive AF (e.g., using phase or contrast detection) in that it can be used in low-light environments, where Passive AF does not function well. A problem with Active AF is that it can only be used for stationary, non-moving objects and only works for close objects. Also, laser diffusion and/or laser power may be insufficient for far away objects. The short comings of Active AF are overcome by using the radio frequency range sensing provided by system 100 shown in FIG. 1.

Process 300 includes: ranging the environment with standard-compliant TX OFDM waveforms (301), triggering AF due to precondition(s) (302), processing received RX OFDM signals (303), determining range, velocity and angle of arrival from the received RX OFDM waveforms (304), determining if the estimated range data can be used for AF (305) and sending the estimated range data to a camera application on the UE (306) for use in Active AF regardless of lighting conditions.

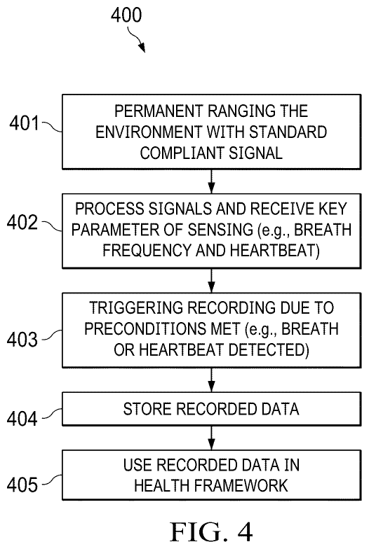

FIG. 4 is a flow diagram of a process 400 for vital sign detection using JCAS parameters, according to one or more embodiments. An example scenario is when the user is sleeping and the UE senses the vital signs of a user, such as detecting breathing or heartbeat. Both heart and respiratory activity cause displacement changes at the body surface, whether the subject is standing, seated, or recumbent. Doppler radar measurement of this displacement provides a real-time signature of a user's respiratory function which can be analyzed to assess the user's respiratory rate, respiratory volume, recognize diagnostic patterns. Micro-Doppler sensing can be used to detect the user's heartbeat. If the user's vital signs (breathing, heartbeat) indicate the user is in distress, the UE can automatically dial an emergency call or perform other action to assist the user or emergency personnel.

Process 400 can be implemented by UE, such as a smartphone or smart watch or in-bed sensor. Process 400 includes: ranging the environment with standard-compliant TX OFDM waveforms (401), receiving, and processing the received RX OFDM waveforms to determine sensed parameters (402), determining that the sensed parameters meet certain preconditions (403), triggering recording of the sensed parameters (404), storing the recorded data (405), and optionally transmitting or otherwise making the recorded data available to a health monitoring application or framework.

In some embodiments, a precondition is the detection of the user's breath or heartbeat. In some embodiments, sensed parameters can include breath frequency and heartbeat. In some embodiments, breathing can be sensed using, for example, the methods described in Li C., Ling J., Li J., Lin J. Accurate Doppler Radar Noncontact Vital Sign Detection Using the RELAX Algorithm. IEEE Trans. Instrum. Meas. 2009; 59:687-695. doi: 10.1109/tim.2009.2025986. In some embodiments, heartbeat can be sensed using micro-Doppler sensing, as described in, for example, Sisman, A. O. Canbaz and K. Yegin, “Micro-doppler radar for human breathing and heartbeat detection,” 2015 Computational Electromagnetics International Workshop (CEM), Izmir, Turkey, 2015, pp. 1-2, doi: 10.1109/CEM.2015.7237422.

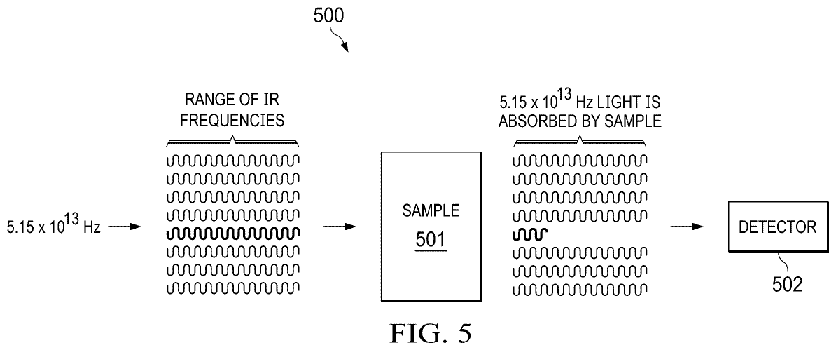

FIG. 5 is a block diagram of a spectroscopy process 500 using JCAS parameters, according to one or more embodiments. An example scenario is a user wants to know from an object of interest (OOI) (e.g., any kind of material), what the object is made of, for example, to avoid food allergies. The user points his UE towards the OOI and the UE displays (and/or audibly recites through a loudspeaker) a list of elements/ingredients comprising the OOI.

Spectroscopic procedures can be used to find molecular transitions of vibrational or electron states with methods like infrared (reflection) spectroscopy or Raman spectroscopy. Infrared laser on the UE could be used like a light source for exciting vibrational or electron state. The spectra of the reflected beam can be analyzed to identify the transition energies and therefore the molecule (e.g., 51.5 THz for a carbonyl double bond molecule).

FIG. 5 illustrates exciting a sample 501 with a range of infrared (IR) frequencies and determining by a detector 502 in the UE, which IR frequencies are absorbed by the sample material. In the example shown, the IR frequency 5.15×10¹³ is absorbed by the sample material creating a “signature” in the frequency spectrum for the molecule, which can then be matched to a reference signature in a database of signatures to identify the molecule. IR spectroscopy, including the example shown, is explained in detail in Soderberg, Timothy, “Organic Chemistry with a Biological Emphasis Volume I” (2019). Chemistry Publications. 1, Ch. 4. Note that depending on the properties of sample 501, the beam can be transmitted through sample 501 resulting in the absorption of IR frequencies before being detected by detector 502, or the beam can be reflected by sample 501 resulting in absorption of some IR frequencies before being detected by detector 502.

### Example Device Architecture

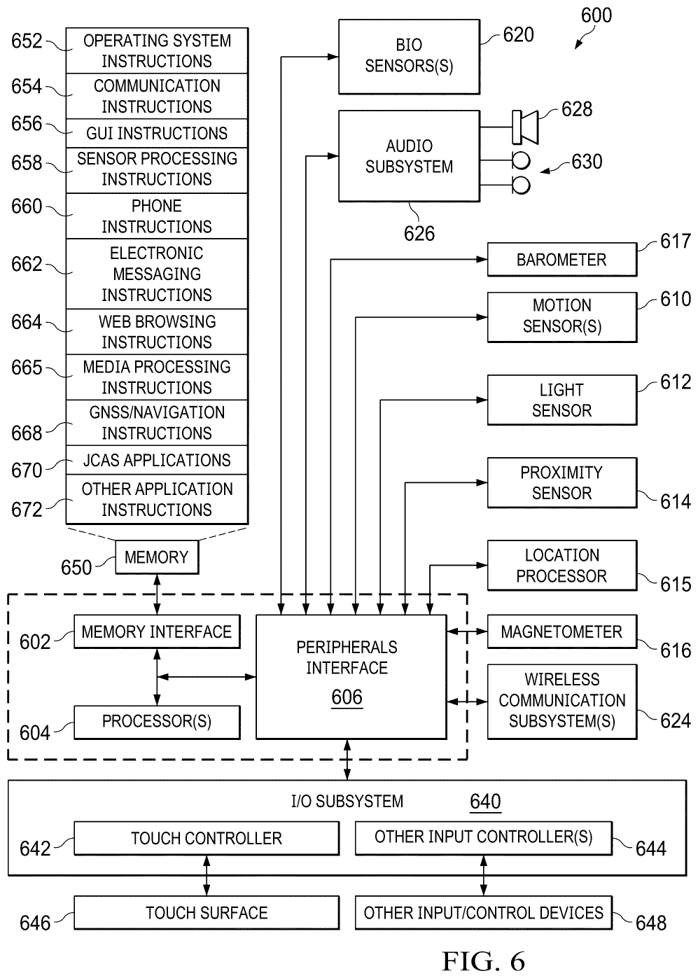

FIG. 6 is a block diagram of a device architecture for implementing the features and processes described in reference to FIGS. 1-5. Architecture 600 can include memory interface 602, one or more hardware data processors, image processors and/or processors 604 and peripherals interface 606. Memory interface 602, one or more processors 604 and/or peripherals interface 606 can be separate components or can be integrated in one or more integrated circuits. System architecture 600 can be included in any suitable electronic device for crash detection, including but not limited to: a smartwatch, smartphone, fitness band and any other device that can be attached, worn, or held by a user.

Sensors, devices, and subsystems can be coupled to peripherals interface 606 to provide multiple functionalities. For example, one or more motion sensors 610, light sensor 612 and proximity sensor 614 can be coupled to peripherals interface 606 to facilitate motion sensing (e.g., acceleration, rotation rates), lighting and proximity functions of the wearable device. Location processor 615 can be connected to peripherals interface 606 to provide geo-positioning. In some implementations, location processor 615 can be a GNSS receiver, such as the Global Positioning System (GPS) receiver. Electronic magnetometer 616 (e.g., an integrated circuit chip) can also be connected to peripherals interface 606 to provide data that can be used to determine the direction of magnetic North. Electronic magnetometer 616 can provide data to an electronic compass application. Motion sensor(s) 610 can include one or more accelerometers and/or gyros configured to determine change of speed and direction of movement. Barometer 617 can be configured to measure atmospheric pressure (e.g., pressure change inside a vehicle). Bio signal sensor 620 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 624, which can include radio frequency (RF) receivers and transmitters (or transceivers) and/or optical (e.g., infrared) receivers and transmitters. The specific design and implementation of the communication subsystem 624 can depend on the communication network(s) over which a mobile device is intended to operate. For example, architecture 600 can include communication subsystems 624 designed to operate over a GSM network, a GPRS network, an EDGE network, a Wi-Fi™ network and a Bluetooth™ network. In particular, the wireless communication subsystems 624 can include hosting protocols, such that the crash device can be configured as a base station for other wireless devices.

Audio subsystem 626 can be coupled to a speaker 628 and a microphone 30 to facilitate voice-enabled functions, such as voice recognition, voice replication, digital recording, and telephony functions. Audio subsystem 626 can be configured to receive voice commands from the user. Audio subsystem 626 can be used to capture audio during a crash and to convert the audio to SPL for crash detection processing.

I/O subsystem 640 can include touch surface controller 642 and/or other input controller(s) 644. Touch surface controller 642 can be coupled to a touch surface 646. Touch surface 646 and touch surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 646. Touch surface 646 can include, for example, a touch screen or the digital crown of a smart watch. I/O subsystem 640 can include a haptic engine or device for providing haptic feedback (e.g., vibration) in response to commands from processor 604. In an embodiment, touch surface 646 can be a pressure-sensitive surface.

Other input controller(s) 644 can be coupled to other input/control devices 648, such as one or more buttons, rocker switches, thumbwheel, infrared port, and USB port. The one or more buttons (not shown) can include an up/down button for volume control of speaker 628 and/or microphone 630. Touch surface 646 or other controllers 644 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 646; and a pressing of the button for a second duration that is longer than the first duration may turn power to the mobile device on or off. The user may be able to customize a functionality of one or more of the buttons. The touch surface 646 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 602 can be coupled to memory 650. Memory 650 can include high-speed random-access memory and/or non-volatile memory, such as one or more magnetic disk storage devices, one or more optical storage devices and/or flash memory (e.g., NAND, NOR). Memory 650 can store operating system 652, such as the iOS operating system developed by Apple Inc. of Cupertino, California. Operating system 652 may include instructions for handling basic system services and for performing hardware dependent tasks. In some implementations, operating system 652 can include a kernel (e.g., UNIX kernel).

Memory 650 may also store communication instructions 654 to facilitate communicating with one or more additional devices, one or more computers and/or one or more servers, such as, for example, instructions for implementing a software stack for wired or wireless communications with other devices. Memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GNSS/Location instructions 668 to facilitate generic GNSS and location-related processes and instructions; and JCAS applications 670 that implement the processes described in reference to FIGS. 2-5. Memory 650 further includes other application instructions 672 including but not limited to instructions for applications that utilize JCAS parameters obtained from system 100 shown in FIG. 1.

### Improved Peak Detection With Apodization Map

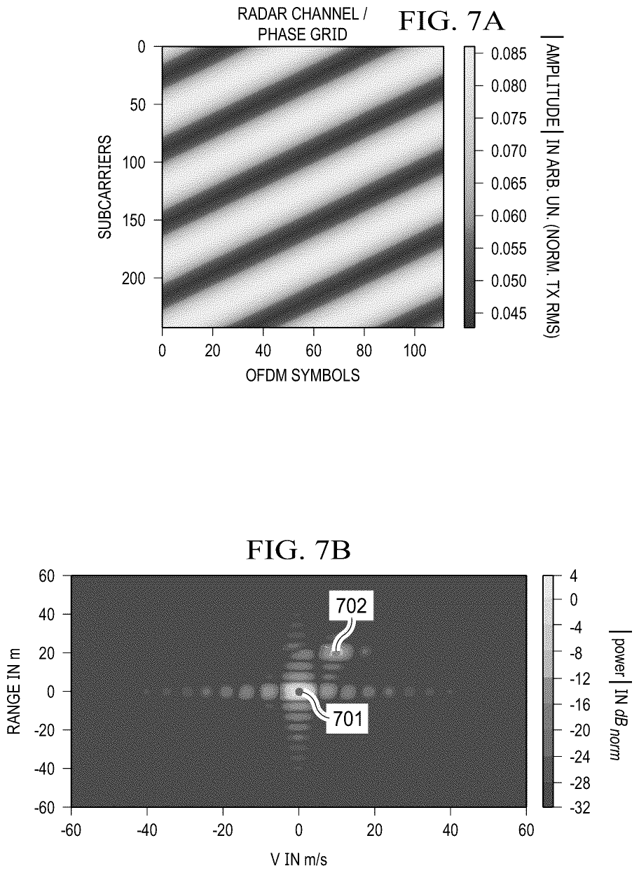

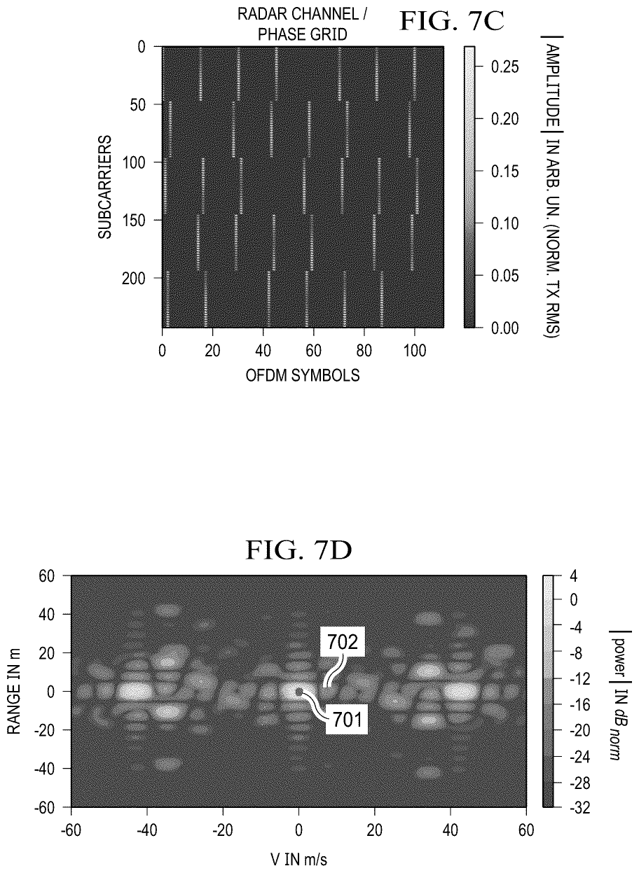

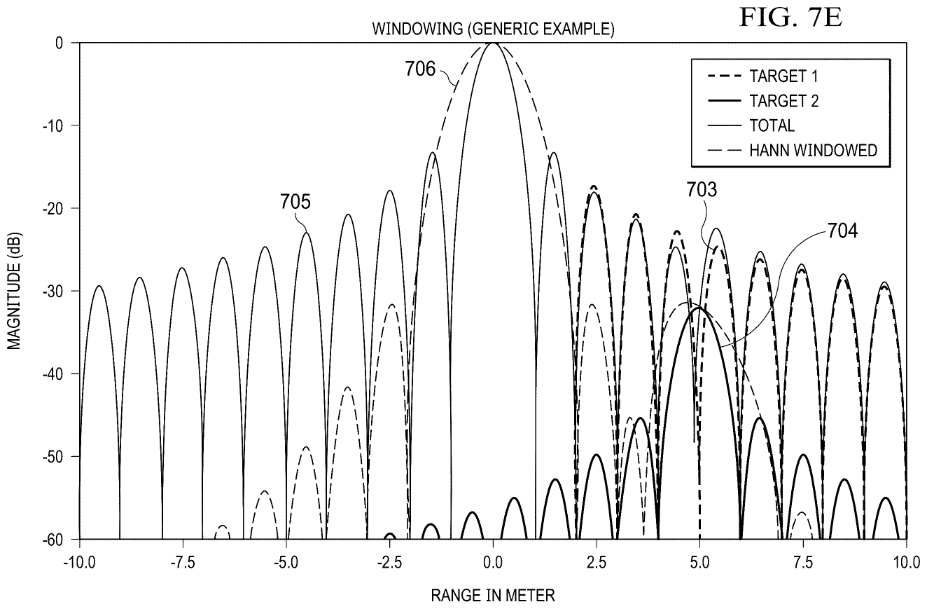

FIG. 7A illustrates a TX resource grid with uniform resource distribution, according to one or more embodiments. The x-axis is OFDM symbols and the y-axis is subcarriers. The uniform resource distribution allows for accurate peak detection of two targets 701 (target 1), 702 (target 2) in the range-velocity map shown in FIG. 7B, where both the targets 701 and 702 are correctly detected.

The 5G NR standard allows for various resource allocations for its signal (also SRS) within 5G OFDM resource grid. The resource grid is used to allocate resources (i.e. complex data symbols) in time and frequency for communication and sensing. The smallest resource units are called resource blocks. A resource block is a group of NRB=12 consecutive subcarriers within one OFDM symbol that are allocated to a user. Assume a time period of one radio subframe with a duration of 1 millisecond (ms) during which several resources blocks can be allocated. The maximum number of resource blocks available within this period is denoted by NRB. This number depends on the specific application and the network requirements.

The 5G standard enables highly dynamic resource allocation, allowing for real-time adaptation to changing network conditions, radio channel and user requirements. This dynamic allocation enables efficient sharing of resources between different users and applications, improving the overall system performance, but can lead to various different resource allocations for one UE from almost full, down to sparse resources available for range and velocity estimation. In the latter case reduced sensing performance might result in scenarios where a target is obscured by the sidelobes of, e.g., the TX/RX leakage present in every radar system.

FIG. 7C illustrates a TX resource grid with non-uniform resource distribution, according to one or more embodiments. The non-uniform resource distribution results in less accurate peak detection (less than uniform resource distribution) in the range-velocity map shown in FIG. 7D. Note the distorted range-velocity map with varying sidelobes. In this example, target 702 is incorrectly detected.

FIG. 7E is a graph illustrating the problem with non-uniform resource distribution, according to one or more embodiments. The sinc functions 703, 704 for the return signals of targets 1 and 2, respectively, and the sinc function 705 for the combined return signal of targets 1 and 2 are shown together with a Hann window 706. The side lobes of the sinc function 705 of the combined return signals masks the peak of the sinc function 704 for target 2 in the range-velocity map, which makes it difficult for the coarse and fine peak search algorithms described in reference to FIG. 1 to detect the peak of target 2 in the range-velocity map.

Sensing performance can benefit from windowing of the baseband signals, which suppresses sidelobes and enables the detection of targets obscured by the sidelobes. To improve peak detection accuracy, a conventional Hann window 703 can be applied to each channel to reduce the side lobe level (SLL) of the baseband signal prior to frequency transformation and peak detection. Traditional window or filter coefficients, however, may underperform due to the properties of SRS. As a result, optimized window coefficients can be used.

In some embodiments, a range-velocity map D can be generated using optimized windows, where the optimization of the windows uses a weighted least squares (WLS) formulation as follows. The range-velocity map D is computed using a two-dimensional Fourier transform with optimized window coefficients. The formula is given by:

$$D = {F}_{τ} ( {W}_{opt} ∘ {Y}_{RX}^{ch} ) {F}_{d}^{T} , \qquad [ 1 ]$$

where F_{τ} and F_{D} are the inverse discrete Fourier transform (IDFT) and discrete Fourier transform, respectively, Wₒₚₜ is a matrix of optimized window coefficients and Y_{RX}^{ch} is the channel matrix.

To use the WLS method, the optimization problem is brought into a matrix-vector form like Ax=b. In this context, b=Δ_{W}=vec(D) is the vectorized range-velocity map, A=Γ, where Γ=F_{d}⊗F_{τ}, is the transformation matrix, a=Ψₒₚₜ·Φ_{RX}^{ch} is the element-wise product of the vectorized window coefficients and the vectorized channel matrix.

This formulation can now be used for the WLS optimization computation:

$${Δ}_{W} = Γ ( {Ψ}_{opt} ∘ {Φ}_{RX}^{ch} ) . \qquad [ 2 ]$$

The WLS optimization solution is given by:

$${Ψ}_{opt} = {( {Γ}^{H} {Ω}_{W} Γ )}^{- 1} {Γ}^{H} {Ω}_{W} \tilde{Δ} , \qquad [ 3 ]$$

where Ω_{W} is a diagonal matrix, Γ^{H} is the Hermitian transpose of Γ, and \tilde{Δ} is the vectorized form of the desired range-velocity map, e.g., a dirac at the target position.

For apodization, there are N different Ω_{W,i}, for i=1 to N, which results in N different Ψ_{opt,i}.

The optimized range-velocity map D_{opt,i} for each i can be calculated using the weights:

$${W}_{opt , i} = {vec}^{- 1} ( {Ψ}_{opt , i} ) . \qquad [ 4 ]$$

Subsequently, the range-velocity map is:

$${D}_{opt , i} = {F}_{τ} ( {W}_{opt , i} ∘ {Y}_{RX}^{ch} ) {F}_{d}^{T} . \qquad [ 5 ]$$

Finally, the apodization step involves applying a nonlinear function element-wise over all the optimized maps. For example, taking the element-wise minimum:

$${[ {D}_{apod} ]}_{m , n} = {min}_{i} ( {[ {D}_{opt , i} ]}_{m , n} ) . \qquad [ 6 ]$$

More generally, any nonlinear function ƒ(·) can be applied element-wise:

$${[ {D}_{apod} ]}_{m , n} = f ( {[ {D}_{opt , 1} ]}_{m , n} , {[ {D}_{opt , 2} ]}_{m , n} , … , {[ {D}_{opt , N} ]}_{m , n} ) , \qquad [ 7 ]$$

where [D_{apod}]_{m,n} represents the result of applying the function element-wise over all the optimized maps at position (m,n).

The overall apodized range-velocity map D_{apod} is then obtained as:

$${D}_{apod} = [ \begin{matrix}{[ {D}_{apod} ]}_{1 , 1} & {[ {D}_{apod} ]}_{1 , 2} & … & {[ {D}_{apod} ]}_{1 , N} \\ {[ {D}_{apod} ]}_{2 , 1} & {[ {D}_{apod} ]}_{2 , 2} & … & {[ {D}_{apod} ]}_{2 , N} \\ ⋮ & ⋮ & ⋱ & ⋮ \\ {[ {D}_{apod} ]}_{M , 1} & {[ {D}_{apod} ]}_{M , 2} & … & {[ {D}_{apod} ]}_{M , N}\end{matrix} ] . \qquad [ 8 ]$$

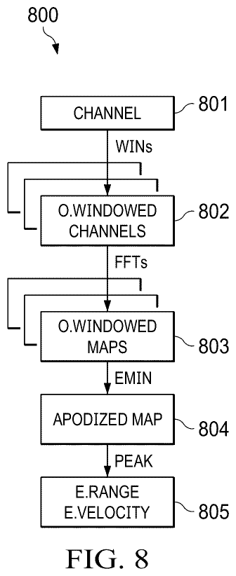

FIG. 8 is a flow diagram of a process 800 that improves the estimate of target range-velocity using an apodization map, according to one or more embodiments. Process 800 includes applying an optimized window to the channel information extracted from the baseband signal on each subcarrier channel 801 to obtain a plurality of optimized windowed channels 802. A frequency transform 803 (e.g., FFT) is applied to each windowed channel 802 to obtain a plurality of optimized windowed range-velocity maps 803. In some embodiments, an energy minimization function is applied to the plurality of optimized windowed range-velocity maps 803 to obtain apodized range-velocity map 804. The coarse and fine peak searching algorithms are applied to apodized map 804 to more accurately estimate (versus estimates with no optimized windows or a single optimized window applied to the combined channels) the range and velocity of one or more targets associated with the RX waveforms.

In process 800 above, there are various optimized windowing approaches that can be used which are described fully in Appendix A. In some embodiments, the apodized range-velocity map 804 is generated by performing an element-wise minimum of the plurality of optimized windowed range-velocity maps 803.

Each of the above identified instructions and applications can correspond to a set of instructions for performing one or more functions described above. These instructions need not be implemented as separate software programs, procedures, or modules. Memory 650 can include additional instructions or fewer instructions. Furthermore, various functions of the mobile device may be implemented in hardware and/or in software, including in one or more signal processing and/or application specific integrated circuits.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method comprising:
transmitting, with a joint communication and sensing system implemented in user equipment (UE), orthogonal frequency-division multiplexing (OFDM) waveforms into an environment;
determining, with at least one processor, if at least one precondition is met;
responsive to determining that at least one precondition is met, triggering, with the at least one processor, a collision alert application on the UE;
processing, with the at least one processor, received OFDM waveforms reflected from at least one object in the environment;
determining, with the at least one processor, at least one sensed parameter determined from the received OFDM waveforms;
comparing, with the at least one processor, the at least one sensed parameter to at least one threshold for presenting at least one collision alert; and
responsive to the at least one sensed parameter meeting the at least one threshold, presenting the at least one collision alert to the user.

2. A method comprises:
transmitting, with a joint communication and sensing system implemented in user equipment (UE), orthogonal frequency-division multiplexing (OFDM) waveforms into an environment;
processing, with at least one processor, received OFDM waveforms to determine at least one sensed parameter associated with at least one vital sign of a user;
determining, with at least one processor, that the at least one sensed parameter meeting at least one precondition;
responsive to the at least one sensed parameter meeting at least one precondition, triggering, with the at least one processor, recording of the at least one sensed parameter or other data; and
storing, transmitting, or making the recording available to at least one application or framework.

3. A method comprising:
transmitting, with a joint communication and sensing system implemented in user equipment (UE), orthogonal frequency-division multiplexing (OFDM) waveforms into an environment;
triggering, with at least one processor, autofocus (AF) for a camera system in the UE in response to at least one precondition being satisfied;
processing, with the at least one processor, received OFDM waveforms;
determining, with the at least one processor, an estimated range to an object from the received OFDM waveforms;
determining, with at least one processor, if the estimated range can be used for AF; and
responsive to determining that estimated range can be used for AF,
sending the estimated range data to the camera system for use in AF.

4. A method comprising:
transmitting, with a joint communication and sensing system implemented in user equipment (UE), waveforms into an environment;
processing, with the at least one processor, received waveforms to determine a molecular signature from spectra of the received waveforms; and
identifying, with the at least one processor, a molecule based on a comparison of the signature with a database of reference signatures and selecting a closest matching reference signature as the identity of the molecule.

5. An apparatus comprising:
at least one processor;
memory storing instructions that when executed by the at least one processor, cause the at least one processor to perform any of the methods 1-4.

6. A computer-readable storage medium having instructions stored there that when executed by one or more processors of a wearable device, perform any of the methods 1-4.

7. A method comprising:
transmitting, with a joint communication and sensing system implemented in user equipment (UE), orthogonal frequency-division multiplexing (OFDM) waveforms into an environment;
processing, with the at least one processor, received OFDM waveforms reflected from at least one object in the environment, the process including:
downconverting the received OFDM waveforms into baseband signals;
applying an optimized window to channel information extracted from the baseband signals;
applying a frequency transform to the windowed baseband signals to obtain windowed range-velocity maps;
generating, with the at least one processor, an apodization range-velocity map from the windowed range-velocity maps; and
estimating, based on the apodization range-velocity map, the range and velocity of the at least one object.

8. The method of claim 7, wherein the apodization range-velocity map is generated by computing an element-wise minimum of the windowed range-velocity maps.
